(19) United States
(12) Patent Application Publication
(10) Pub. No.: US 2022/0096302 A1
(43) Pub. Date: Mar. 31, 2022

(54) BEDPAN ASSEMBLY

(71) Applicant: VERNACARE LIMITED, Bolton, Lancashire (GB)

(72) Inventors: Wayne Nelson, Radcliffe (GB); Nathan Shields, Bolton (GB)

(21) Appl. No.: 17/297,989

(22) PCT Filed: Nov. 27, 2019
(86) PCT No.: PCT/GB2019/053345

§ 371 Date: May 27, 2021

(30) Foreign Application Priority Data
Nov. 28, 2018 (GB) 1819386.2

(51) Int. Cl. A61G 9/00

(52) U.S. Cl. CPC A61G 9/003

(57) ABSTRACT

A bedpan assembly comprises a bedpan having a base wall and an enclosing wall extending upwardly from the base wall, the base wall and the enclosing wall defining a receiving volume, and an insert complementarily shaped with a portion of the enclosing wall and engageable with a complementarily-shaped portion of the enclosing wall in an inserted position. The insert comprises an upper wall which, when the insert is in the inserted position, overlies or overhangs the base wall. The separately-formed insert which is engageable with, and receivable in, the receiving volume of the bedpan immediately prior to use facilitates storage of the bedpans prior to use (e.g. they can be stacked together) and reduces the likelihood of spillage when the bedpan assembly is removed for disposal.

Bedpans are used by patients in hospitals, nursing homes and the like, where it is difficult or impossible for the patient to visit a toilet. In order to reduce the risk of cross-infection, the use of disposable bedpans is preferred. Disposable bedpans are made from dried, moulded paper pulp which, after use, are reduced to small particles in a macerator and discharged into the normal drainage system.

Disposable bedpans are not generally capable of supporting the weight of a user, since they are made from dried, moulded paper pulp. It is therefore usual to use a disposable bedpan in conjunction with a reusable support in order to prevent the disposable bedpan from collapsing in use.

One type of known disposable bedpan is a so-called “slipper” bedpan. Examples of such bedpans are those sold by Vernacare® under the names Maxi Slipper Pan Liner™ and Midi Slipper Pan Liner™. Slipper bedpans have a recessed receiving portion at their rear and have a generally wedged-shaped profile, with a lower profile at the front of the bedpan and a higher profile at the rear of the bedpan. The front portion of slipper bedpans comprises a generally planar surface which extends forwardly beyond the front of the recessed receiving portion and provides a surface which engages the patient and thereby partially supports the patient's weight during use. The wedge-shaped profile and planar front support surface facilitate positioning of the bedpan beneath the user and improve the comfort of the bedpan.

However, the planar front support surface increases the overall size of the bedpan but does not increase the volume of the receiving portion. Moreover, the tapering wedge-shaped profile results in a relatively low front wall of the recessed receiving portion, which inhibits the capacity of the receiving volume and also increases the likelihood of spillage during removal of the bedpan by the patient and during subsequent transportation.

The known slipper bedpans are moulded from dried paper pulp and are disposed of after use in a macerator. In use, the bedpans are therefore releasably supported on a complementarily-shaped reusable bedpan support, to prevent collapsing of the bedpan.

Another type of disposable bedpan is the so-called “French Slipper Pan”, which also has a generally wedge-shaped profile for comfort and ease of use. The recessed receiving portion is defined by a base wall and a side wall extending around the periphery of the base wall, but the front portion of the receiving portion is covered with a top wall which is permanently secured to the periphery of a portion of the side wall using adhesive, whereby the top wall permanently overlies the front portion of the base wall.

The provision of a permanently secured top wall which overlies a portion of the base wall forms a pocket in which contents of the receiving volume may be retained by tipping up the base wall, thereby reducing the likelihood of spillage of the contents during transportation.

However, the French Slipper Bedpan requires the top wall to be permanently secured with adhesive in order to form a reliable seal between the lid and the bedpan. This prevents bedpans from being nested with one another, which greatly increases the volume necessary for transportation and storage of the bedpans. Moreover, disposal of a soiled bedpan in a macerator is more difficult, because of the glued portions.

The bedpan disclosed in WO2016046564 A1 overcomes or alleviates many of the aforementioned problems. However, that bedpan requires a more complicated, and therefore more expensive, moulding procedure and also uses considerably more paper pulp in its construction. The increased volume of paper pulp to be disposed of in a macerator can limit the number of such bedpans which can be processed in an operating cycle of the macerator.

In accordance with a first aspect of the present invention, a bedpan assembly comprises:

a bedpan having a base wall and an enclosing wall extending upwardly from the base wall, the base wall and the enclosing wall defining a receiving volume; and

an insert complementarily shaped with a portion of the enclosing wall and engageable with the complementarily-shaped portion of the enclosing wall in an inserted position, the insert comprising an upper wall which, when the insert is in the inserted position, overlies or overhangs the base wall.

The provision of a separately-formed insert which is engageable with, and receivable in, the receiving volume of the bedpan immediately prior to use facilitates storage of the bedpans prior to use (e.g. they can be stacked together) and reduces the likelihood of spillage when the bedpan assembly is removed for disposal.

Preferably, the insert is complementarily-shaped with a portion of the base wall.

Preferably, wherein when the insert is in the inserted position, the upper wall is at substantially the same level as the upper edge of the enclosing wall.

The bedpan assembly preferably comprises means for retaining the insert in the inserted position.

In one embodiment, the enclosing wall comprises one or more projections which engage the insert when the insert is in the inserted position.

In one embodiment, the insert comprises supporting means extending from the upper wall and engageable with the enclosing wall and/or the base wall when the insert is in the inserted position.

The insert may comprise an enclosing wall extending from a portion of the periphery of the upper wall of the insert and engageable with the enclosing wall and/or the base wall of the receiving volume when the insert is in the inserted position.

The insert may further comprise a base wall extending from the enclosing wall of the insert and engageable with a portion of the base wall of the receiving volume.

The base wall of the insert is preferably substantially planar.

In one embodiment, the upper wall, the enclosing wall and the base wall define an open concavity.

Preferably, a plurality of the inserts are nestable with each other.

This allows a plurality of inserts to be stacked in nested fashion, which reduces the volume required for storage. When required, one of the inserts can be selected and inserted into the receiving volume of a bedpan.

Preferably, the upper wall of the insert is substantially planar.

The bedpan may further comprise a seat portion extending from the periphery of a portion of the enclosing wall, the insert being located adjacent to the seat portion of the bedpan when the insert is in the inserted position.

Preferably, the seat portion of the bedpan and the upper wall of the insert of generally planar and wherein the seat portion and the upper wall of the insert are substantially coplanar when the insert is in the inserted position.

The height of the enclosing wall may reduce from a rear portion of the receiving volume to a front portion of the receiving volume.

Preferably, the insert is engageable with a portion of the enclosing wall located at the front portion of the receiving volume.

Preferably, a plurality of bedpans are nestable with each other.

Preferably, the bedpan and/or the insert are formed from maceratable material, for example dried, moulded paper pulp.

In accordance with a second aspect of the present invention, there is provided an insert for a bedpan of the type having a base wall and an enclosing wall extending upwardly from the base wall, the base wall and the enclosing wall defining a receiving volume, the insert being complementarily shaped with a portion of the enclosing wall of the bedpan and engageable with the complementarily-shaped portion of the enclosing wall in an inserted position, the insert comprising an upper wall which, when the insert is in the inserted position, overlies or overhangs the base wall.

Preferably, the insert is complementarily-shaped with a portion of the base wall.

Preferably, when the insert is in the inserted position, the upper wall is configured to be at substantially the same level as the upper edge of the enclosing wall.

In one embodiment, the insert comprises supporting means extending from the upper wall and engageable with the enclosing wall and/or the base wall when the insert is in the inserted position.

In one embodiment, the insert comprises an enclosing wall extending from a portion of the periphery of the upper wall of the insert and engageable with the enclosing wall and/or the base wall of the receiving volume of the bedpan when the insert is in the inserted position.

Preferably, the insert comprises a base wall extending from the enclosing wall of the insert and engageable with a portion of the base wall of the receiving volume of the bedpan.

The base wall of the insert may be substantially planar.

In one embodiment, the upper wall, the enclosing wall and the base wall define an open concavity.

Preferably, a plurality of the inserts are nestable with each other.

Preferably, the upper wall of the insert is substantially planar.

Preferably, the insert is formed from maceratable material, for example dried, moulded paper pulp.

In accordance with a third aspect of the present invention, a bedpan comprises a base wall and an enclosing wall extending upwardly from the base wall, the base wall and the enclosing wall defining a receiving volume, a portion of the enclosing wall being configured to engage with and receive a complementarily shaped insert in an inserted position, the insert having upper wall which, when the insert is in the inserted position, overlies or overhangs the base wall.

Preferably, the bedpan is formed from maceratable material, for example dried, moulded paper pulp.

By way of example only, a specific embodiment of the present invention will now be described with reference to the accompanying drawings, in which:

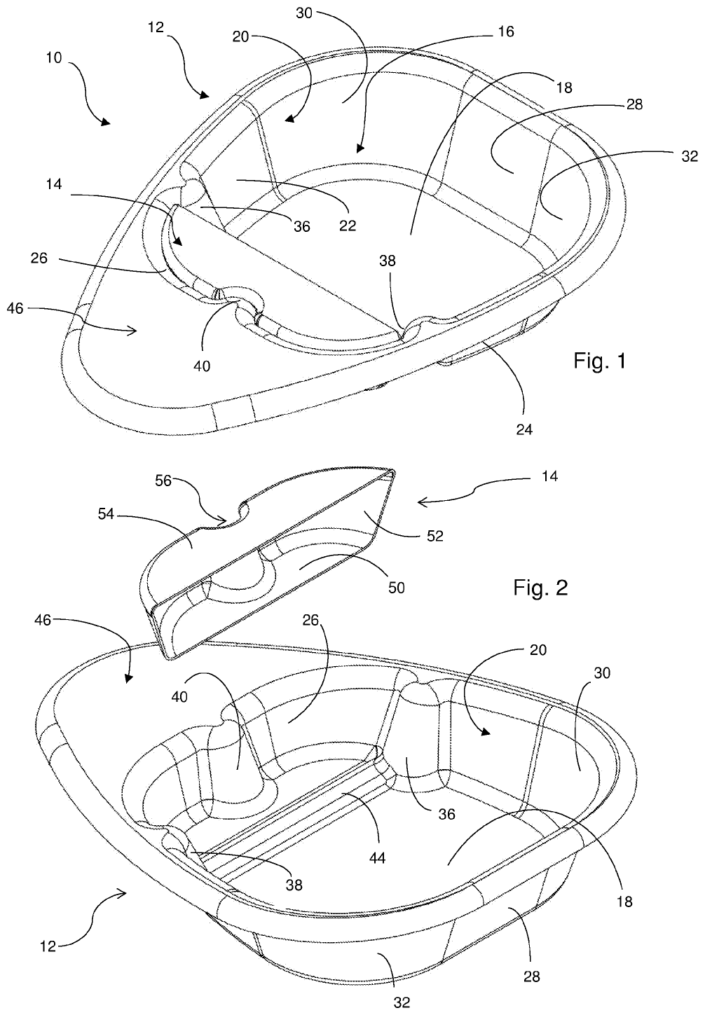

FIG. 1 is a front perspective view from above of an embodiment of bedpan assembly in accordance with the present invention, in the form of a bedpan fitted with a removable insert;

FIG. 2 is a rear perspective view from above of the bedpan assembly of FIG. 1, with the insert removed;

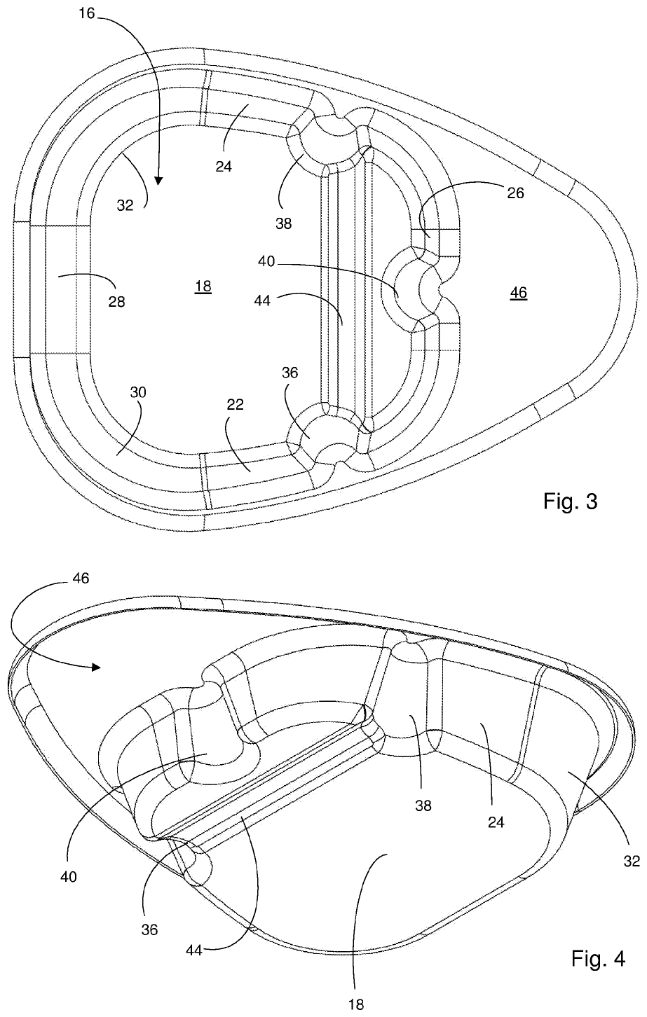

FIG. 3 is a plan view of the bedpan of FIG. 1;

FIG. 4 is a front perspective view from below of the bedpan assembly of FIG. 1;

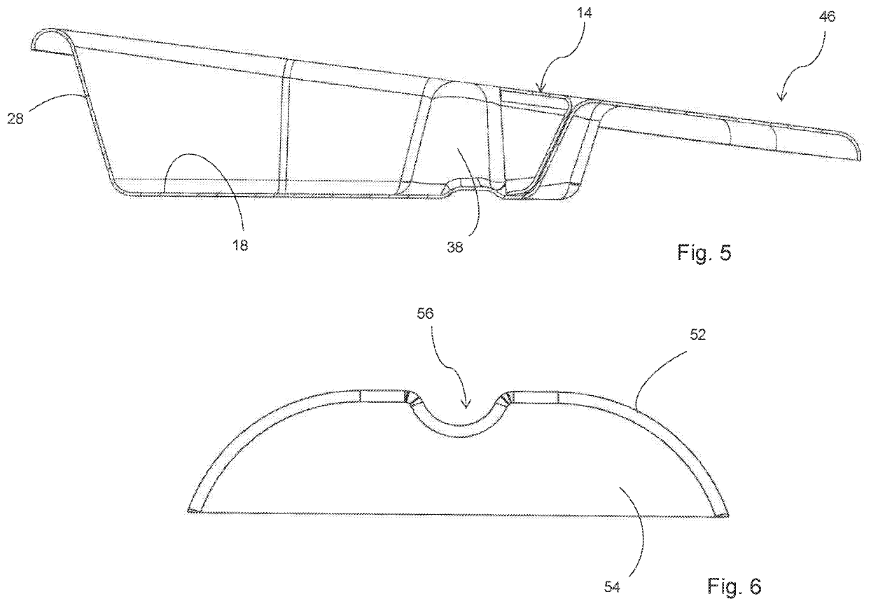

FIG. 5 is a vertical cross-section along the longitudinal centre line of the bedpan assembly of FIG. 1;

FIG. 6 is a plan view of the insert of FIG. 1;

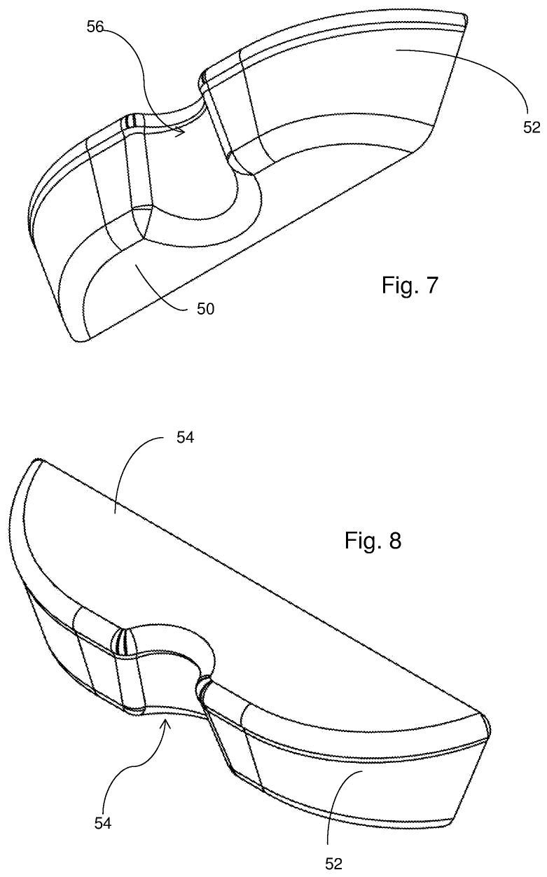

FIG. 7 is a front perspective view from below of the insert of FIG. 1;

FIG. 8 is a front perspective view from above of the insert of FIG. 1;

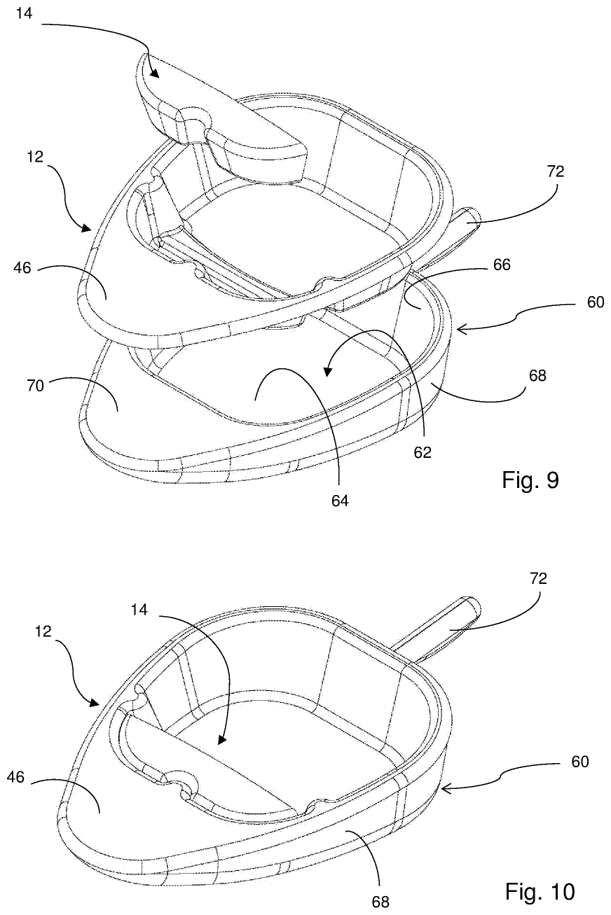

FIG. 9 is a front perspective view from above of the bedpan assembly of FIG. 1, prior to being positioned on a reusable support; and

FIG. 10 is a front perspective view from above of the bedpan assembly of FIG. 1, positioned on the reusable support.

A bedpan assembly 10 comprises a bedpan 12 and an insert 14 which can be removably fitted into the bedpan. The bedpan 12 and insert 14 are both formed from dried, moulded paper pulp which is maceratable and intended to be disposed of in a standard macerator.

The bedpan 12 comprises a receiving volume 16 defined by a generally planar base wall 18 and an enclosing wall 20 extending upwardly and outwardly from the periphery of the base wall. The enclosing wall 18 comprises two side wall portions 22, 24 which taper towards each other and which merge with a respective end of a generally arcuate front wall portion 26. Each of the opposite ends of the side wall portions 22, 24 merges with a respective end of a straight rear wall portion 28 by means of a respective curved corner portion 30, 32.

As best seen in FIG. 5, the height of the rear wall portion 28 is greater than the height of the front wall portion 26, whereby the bedpan assumes a wedge-like shape in longitudinal cross-section, such that the height of the enclosing wall decreases from a maximum at the rear wall portion 28 to a minimum at the front wall portion 26.

Upstanding projections 36, 38 are moulded into the enclosing wall 20 at the junction of each of the side wall portions 22, 24 and the respective end of the front wall portion 26 and project into the receiving volume 16. Similarly, a projection 40 is moulded into the centre of the front wall portion 26. Each of the projections 36, 38, 40 is generally partly frusto-conical in shape (approximately half a cone with a rounded top level with the upper edge of the enclosing wall 20) and merges smoothly with the base wall 18 and with the portion of the enclosing wall 20 from which it projects.

A straight, elongate transversely extending projection 44 extending between the bases of the two projections 36, 38 is moulded into the generally planar base wall 18 and forms a weir to inhibit the movement of liquid within the receiving volume, as will be explained.

A planar, generally triangular seat portion 46 projects outwardly from the front wall portion 26 for engagement with the backside of a patient, as will be explained. When viewed from above, therefore, the bedpan is generally tear-shaped. It will also be observed from the FIGS. 1 to 5 that the periphery of the bedpan is moulded to form an overturned, rounded lip, for comfort.

The insert 14 is shaped complementarily with the portion of the base wall 18 and the enclosing wall 20 located between the transversely extending projection 44 in the base wall 18 and the front wall portion 26. In particular, the insert comprises a generally planar and lenticular base wall 50 of the same size and shape of the portion of the base wall 18 forwardly of the projection 44, upstanding wall portion 52 extending upwardly and outwardly from the base wall 50 which is shaped to be a complementary fit with the front wall portion 26 and a planar upper wall 54 extending inwardly over the base wall 50. In particular, it will be observed that a recess 56 which is a complementary fit to the projection 40 moulded into the centre of the front wall portion 26 is moulded into the centre of the upstanding wall portion 52. The insert 14 is open the rear, as best seen in FIGS. 2 and 5.

The insert 14 can be inserted vertically into the front portion of the receiving volume 16 located between the transversely extending portion 44 in the base wall 18 and the front wall portion 26, as illustrated in FIG. 1. In this configuration, the insert 14 is nested into the front portion of a receiving volume 18, with the base wall 50 of the insert in contact with the front portion of the base wall of the bedpan and the upstanding wall portion 52 of the insert in contact with the front wall portion 26 of the receiving volume 18. In this condition, the planar upper wall 54 of the insert is aligned with the triangular seat portion 40 of the bedpan 12 and overlies or overhangs the base wall 18 of the bedpan 12.

When engaged with the bedpan 12, the insert 14 is prevented from moving laterally by its engagement with the front wall portion 26 of the bedpan 12, the upstanding projections 36, 38 and the transversely extending projection 44 in the base wall 18. The insert 14 can only be removed from the bedpan 12 by lifting it vertically out of the front portion of the receiving volume 16, as shown in FIG. 2.

As can be seen from the Figures, the enclosing wall 20 of the receiving volume 16 flares upwardly, such that the periphery of the uppermost portion of the enclosing wall 20 is larger than the periphery of the base wall 18. This allows multiple identical bedpans 12 to be stacked in a nested fashion, which significantly reduces the space required to store bedpans. Similarly, the inserts 14 are designed so that multiple identical inserts can be stacked in a nested fashion, which again reduces the space required to store inserts.

The bedpans 12 and inserts 14 would normally be stored separately to reduce storage space, as described above. When a patient requires use of a bedpan, one bedpan 12 and one insert 14 are taken and the insert 14 is placed into the front portion of the receiving volume 16 of the bedpan 12, as illustrated in FIG. 1. As described previously, when the insert 14 is positioned in the front portion of the receiving volume 16, it is a snug fit against the front wall portion 26. In particular, it cannot be moved laterally, forwardly or rearwardly and can only be removed vertically, as indicated in FIG. 2. When in this position, the planar upper wall 54, which is level with the triangular seat portion 40 of the bedpan 12, overlies or overhangs the base wall 18 of the bedpan 12.

In use, the bedpan assembly 10 is normally placed on a reusable moulded plastics support 60, shown in FIGS. 9 and 10, which is able to bear the weight of a patient. The support 60 is shaped complementarily to the undersurface of the bedpan 12 and in particular comprises a receiving volume 62 defined by a generally planar base wall 64 and an inner enclosing wall 66 extending upwardly and outwardly from the periphery of the base wall. An outer enclosing wall 68 is located outwardly of the inner base wall 66 and a triangular portion 46, shaped complementarily to the undersurface of the triangular portion 46 of the bedpan, projects forwardly from the front edge of the receiving volume 62. A handle 72 projects rearwardly from the rear of the outer enclosing wall 68 and the support 60 is generally wedge-shaped in profile, to match the profile of the bedpan 12.

The bedpan assembly 10 and support bowl 60 are then positioned underneath a patient, using the handle 72, so that the triangular seat portion 46 is located beneath the patient's buttocks. The positioning of the bedpan assembly 10 is facilitated by the wedge-shaped profile of the bedpan 12, as shown in FIG. 5. The patient is then able to use the bedpan assembly 10 in the same way as a conventional bedpan.

If a reusable support 60 is not readily available, then a plurality of nested bedpans 12 (typically two or three) can be used instead, with a single insert 14 positioned in the front portion of the receiving volume 16 of the uppermost bedpan 12.

The upper wall 54 of the insert is effectively continuous with the generally triangular seat portion 46, and the support area for a patient is therefore increased, without diminishing the size of the receiving volume 16.

After use, the bedpan assembly 10 and the reusable support 60 (if used) are removed from the patient. The soiled bedpan assembly 10 is then taken to a conventional macerator which reduces the material of the bedpan assembly 10 and its contents to particles of a size small enough to be disposed of in a conventional sewage system. During manual transport of the soiled bedpan assembly 10, the upper wall 54 of the insert, which overlies or overhangs the front portion of the base wall 18, helps to retain liquid within the receiving volume 16 and reduces the splashing of liquids. In addition, the weir formed by the transversely extending projection 44 helps to interrupt the flow of liquid towards the insert 14.

Whilst the above description refers to a “bedpan”, that expression is intended to include its use as a disposable liner to be used in conjunction with a separate support, as referred to above.

In addition, the above description states that when the insert 14 is in the inserted position in the bedpan, its upper wall 54 “overlies or overhangs” the base wall 18 of the bedpan 18. The expression “overhangs or overlies” is intended to include arrangements in which other items or features, e.g. the base wall 50 of the insert 14, are located between the upper wall 54 of the insert 14 and the base wall 18 of the bedpan 12.

The invention is not restricted to the details of the foregoing embodiment.

1. A bedpan assembly comprising:
a bedpan having a base wall and an enclosing wall extending upwardly from the base wall, the base wall and the enclosing wall defining a receiving volume; and
an insert complementarily shaped with a portion of the enclosing wall and engageable with the complementarily-shaped portion of the enclosing wall in an inserted position, the insert comprising an upper wall which, when the insert is in the inserted position, overlies or overhangs the base wall.

2. A bedpan assembly as claimed in claim 1, wherein the insert is complementarily-shaped with a portion of the base wall.

3. A bedpan assembly as claimed in claim 1 or claim 2, wherein when the insert is in the inserted position, the upper wall is at substantially the same level as the upper edge of the enclosing wall.

4. A bedpan assembly as claimed in any of the preceding claims, comprising means for retaining the insert in the inserted position.

5. A bedpan assembly as claimed in claim 4, wherein the enclosing wall comprises one or more projections which engage the insert when the insert is in the inserted position.

6. A bedpan assembly as claimed in any of the preceding claims, wherein the insert comprises supporting means extending from the upper wall and engageable with the enclosing wall and/or the base wall when the insert is in the inserted position.

7. A bedpan assembly as claimed in claim 6, wherein the insert comprises an enclosing wall extending from a portion of the periphery of the upper wall of the insert and engageable with the enclosing wall and/or the base wall of the receiving volume when the insert is in the inserted position.

8. A bedpan assembly as claimed in claim 7, wherein the insert comprises a base wall extending from the enclosing wall of the insert and engageable with a portion of the base wall of the receiving volume.

9. A bedpan assembly as claimed in claim 8, wherein the base wall of the insert is substantially planar.

10. A bedpan assembly as claimed in claim 8 or claim 9, wherein the upper wall, the enclosing wall and the base wall define an open concavity.

11. A bedpan assembly as claimed in claim 10, wherein a plurality of the inserts are nestable with each other.

12. A bedpan assembly as claimed in any of the preceding claims, wherein the upper wall of the insert is substantially planar.

13. A bedpan assembly as claimed in any of the preceding claims, wherein the bedpan further comprises a seat portion extending from the periphery of a portion of the enclosing wall, the insert being located adjacent to the seat portion of the bedpan when the insert is in the inserted position.

14. A bedpan assembly as claimed in claim 13, wherein the seat portion of the bedpan and the upper wall of the insert of generally planar and wherein the seat portion and the upper wall of the insert are substantially coplanar when the insert is in the inserted position.

15. A bedpan assembly as claimed in any of the preceding claims, wherein the height of the enclosing wall reduces from a rear portion of the receiving volume to a front portion of the receiving volume.

16. A bedpan assembly as claimed in claim 15, wherein the insert is engageable with a portion of the enclosing wall located at the front portion of the receiving volume.

17. A bedpan assembly as claimed in any of the preceding claims, wherein a plurality of bedpans are nestable with each other.

18. A bedpan assembly as claimed in any of the preceding claims, wherein the bedpan and/or the insert are formed from maceratable material.

19. A bedpan assembly as claimed in claim 18, wherein the bedpan and/or the insert are formed from dried, moulded paper pulp.

20. An insert for a bedpan of the type having a base wall and an enclosing wall extending upwardly from the base wall, the base wall and the enclosing wall defining a receiving volume, the insert being complementarily shaped with a portion of the enclosing wall of the bedpan and engageable with the complementarily-shaped portion of the enclosing wall in an inserted position, the insert comprising an upper wall which, when the insert is in the inserted position, overlies or overhangs the base wall.

21. An insert as claimed in claim 20, wherein the insert is complementarily-shaped with a portion of the base wall.

22. An insert as claimed in claim 20 or claim 21, wherein when the insert is in the inserted position, the upper wall is configured to be at substantially the same level as the upper edge of the enclosing wall.

23. An insert as claimed in any of claims 20 to 22, wherein the insert comprises supporting means extending from the upper wall and engageable with the enclosing wall and/or the base wall when the insert is in the inserted position.

24. An insert as claimed in claim 23, wherein the insert comprises an enclosing wall extending from a portion of the periphery of the upper wall of the insert and engageable with the enclosing wall and/or the base wall of the receiving volume of the bedpan when the insert is in the inserted position.

25. An insert as claimed in claim 24, wherein the insert comprises a base wall extending from the enclosing wall of the insert and engageable with a portion of the base wall of the receiving volume of the bedpan.

26. An insert as claimed in claim 25, wherein the base wall of the insert is substantially planar.

27. An insert as claimed in claim 25 or claim 26, wherein the upper wall, the enclosing wall and the base wall define an open concavity.

28. An insert as claimed in claim 27, wherein a plurality of the inserts are nestable with each other.

29. An insert as claimed in any of claims 20 to 28, wherein the upper wall of the insert is substantially planar.

30. An insert as claimed in any preceding claims, formed from maceratable material.

31. An insert as claimed in claim 30, formed from dried, moulded paper pulp.

32. A bedpan comprising a base wall and an enclosing wall extending upwardly from the base wall, the base wall and the enclosing wall defining a receiving volume, a portion of the enclosing wall being configured to engage with and receive a complementarily shaped insert in an inserted position, the insert having upper wall which, when the insert is in the inserted position, overlies or overhangs the base wall.

33. A bedpan as claimed in claim 32, formed from maceratable material.

34. A bedpan as claimed in claim 33, formed from dried, moulded paper pulp.
